(19) United States
(12) Patent Application Publication
(10) Pub. No.: US 2018/0332952 A1
(43) Pub. Date: Nov. 22, 2018

(54) MULTI PURPOSE HOLDER FOR BEVERAGE CONTAINER AND ELECTRONIC ACCESORY

(71) Applicant: John Barca, Jensen Beach, FL (US)

(72) Inventor: John Barca, Jensen Beach, FL (US)

(21) Appl. No.: 15/979,506

(22) Filed: May 15, 2018

Related U.S. Application Data
(60) Provisional application No. 62/507,590, filed on May 17, 2017.

(51) Int. Cl. A45F 3/44; B60N 3/10; B60R 11/02

(52) U.S. Cl. CPC A45F 3/44; B60R 11/0241; B60N 3/10

(57) ABSTRACT

A holder for a beverage container and an electronic accessory has a main body. The main body includes a first open ended compartment; the first compartment being substantially cylindrical. A second open ended compartment extends from and being in facing relation with the first compartment, the second compartment being substantially rectangular. A base extends from the housing in a direction away from the first compartment and has a substantially cylindrical outer circumference.

### CROSS REFERENCE TO RELATED APPLICATIONS

This application claims the benefit of U.S. Provisional Application No. 62/507,590 filed May 17, 2017.

### BACKGROUND OF THE INVENTION

The present invention is directed to a structure for holding a beverage container and an electronic accessory, and more particularly, a structure for holding a beverage container and an electronic accessory as a single structure in a hands-free manner in a variety of environments.

Mobile telephones have become ubiquitous in daily life. Users cannot be without them, in the car, at the beach, even at a picnic in the woods. However, phones are not indestructible and must be carried requiring the use of a bag, belt clip, or a hand. At the same time, it is common in a car to drink a beverage, such as a morning coffee, or afternoon water. At the beach, beverages are also consumed requiring the use of another free hand. If someone wants both their beverage and their mobile telephone close by, there must be a way to carry both while allowing at least one free hand.

At the beach, one would not throw either the beverage or the mobile phone into the sand. It could harm the mobile phone, and would quickly heat up any beverage. One could throw the mobile phone into a beach bag when at the beach, or in a handbag when in a car, but then the mobile phone is no longer handy.

The consumption of beverages has become so ubiquitous, that cars and even furniture are now manufactured with cup holders to accommodate beverages. These cup holders have also been utilized to store change, hold parking passes, and even to accommodate electronic accessories, particularly while charging a mobile phone and driving. However, they cannot accommodate both a beverage and these other items simultaneously. Therefore, when a cup holder is utilized to hold a beverage it cannot be used to hold the electronic accessory and vice versa.

Accordingly, a structure overcoming the shortcomings of the prior art is desired.

### SUMMARY OF THE INVENTION

A holder for a beverage container and an electronic accessory includes a main body. The main body has a first compartment, the first compartment being substantially cylindrical. A second compartment extends from and is in facing relation with the first compartment. The second compartment is substantially rectangular. A base extends from the housing in a direction away from the first compartment and has a substantially cylindrical outer circumference.

### BRIEF DESCRIPTION OF THE DRAWINGS

The present disclosure will be better understood by reading the written description with reference to the accompanying drawing figures in which like reference numerals denote similar structure and refer to like elements throughout in which:

FIG. 1 is a top front perspective view of a holder constructed in accordance with the invention;

FIG. 2 is a top plan view of the holder constructed in accordance with the invention;

FIG. 3 is a bottom plan view of the holder constructed in accordance with the invention;

FIG. 4 side elevational view of the holder constructed in accordance with the invention;

FIG. 5 is a sectional view taken along line 5-5 of FIG. 4;

FIG. 6 is a top front perspective view of an anchor constructed in accordance with a second embodiment of the invention;

FIG. 7 is a partial sectional view of the second embodiment of the invention with the anchor secured to the main body of the holder;

FIG. 8 is a bottom plan view of an anchor constructed in accordance with a third embodiment of the invention;

FIG. 9 is a top plan view of the anchor constructed in accordance with a third embodiment of the invention;

FIG. 10 is a side elevational view of the anchor constructed in accordance with the third embodiment invention;

FIG. 11 is a side elevational view of the holder constructed in accordance with the third embodiment of the invention;

FIG. 12 is a sectional view taken along line 12-12 of FIG. 11; and

FIG. 13 is a top perspective view of the anchoring mechanism constructed in accordance with the third embodiment of the invention.

### DETAILED DESCRIPTION OF THE PREFERRED EMBODIMENTS

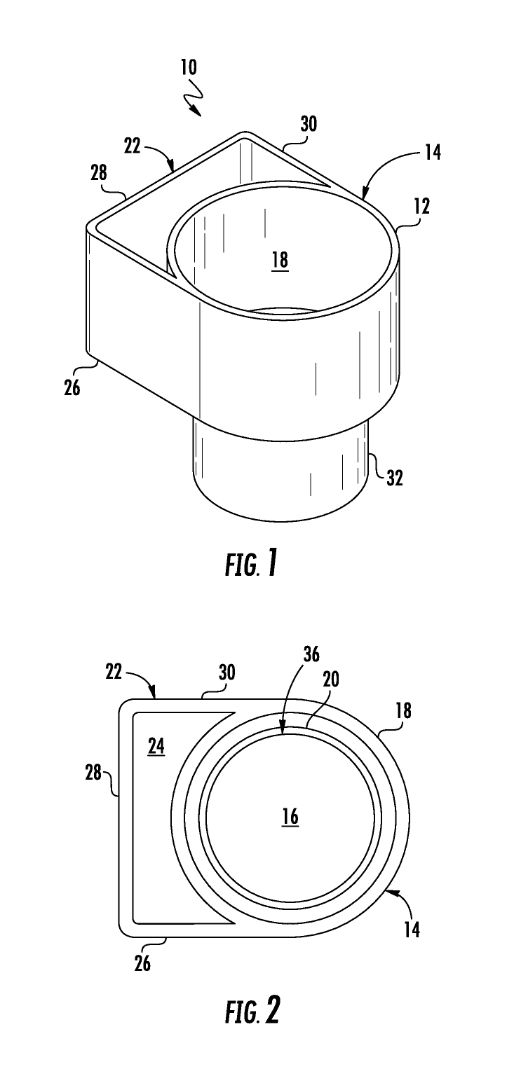

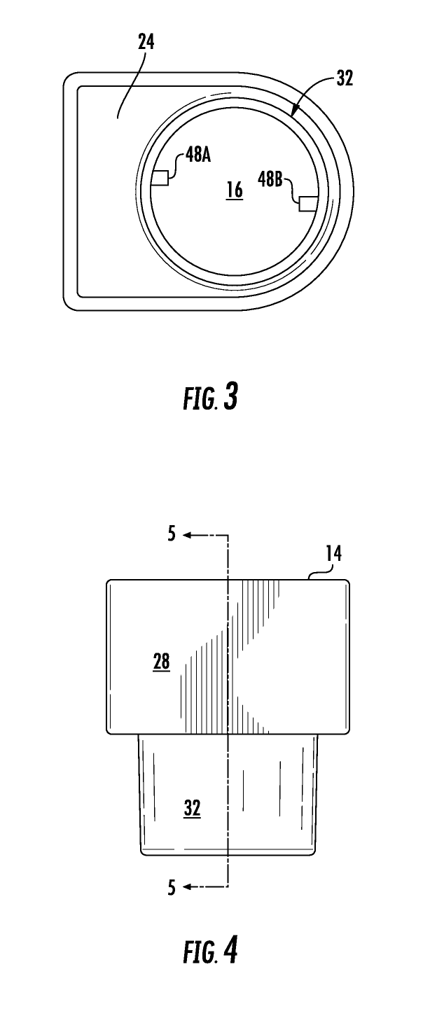

Reference is first made to FIGS. 1-4 in which a holder for holding a beverage and an electronic accessory, such as a mobile phone non-limiting example, constructed in accordance with the invention is provided. A holder 10 includes a main body 12. Main body 12 has a first compartment, cup portion 14, and a second compartment, accessory portion 22, extending from and in facing relation with the cup portion 14, and a base portion 32 which, as will be seen below, acts as an anchoring mechanism.

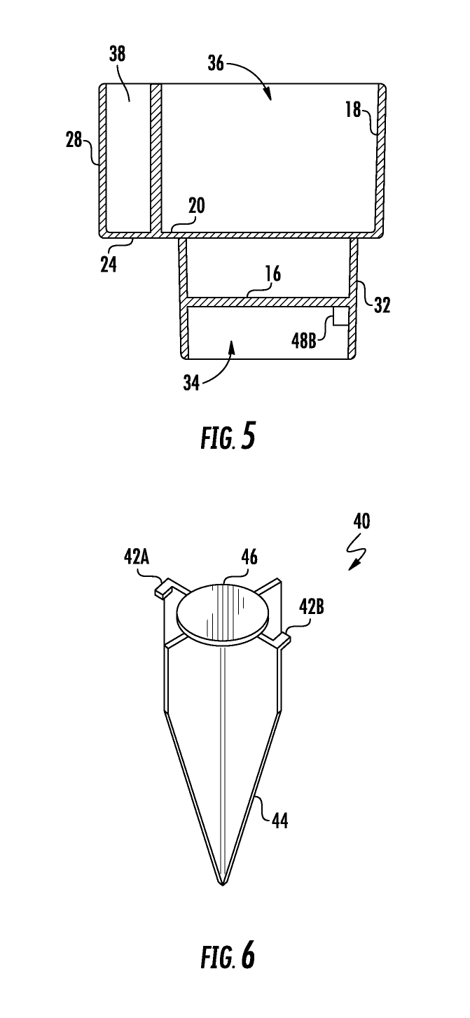

Cup portion 14 includes a cylindrical wall 18 extending with a first open end 36. A floor 16 disposed within cup portion 14 closes the opposed end of cup portion 14. Cylindrical wall 18 has a diameter sufficient to receive and secure a beverage container such as a cup, bottle, or can therein. A second cylindrical wall 32 forming a base portion (and also referred to as cylindrical wall) descends from and communicates with cup portion 14 (FIG. 5). Cylindrical wall 32 is a base to main body 12 and forms an anchor structure as will be described below and in a preferred non-limiting embodiment is substantially hollow; i.e. In a downwardly facing, direction away from cup portion 14, forms an open end 34.

Cylindrical wall 32 has an outer circumference sized and dimensioned to be received and secured by the interior wall of a standard size cup holder; such as that found in vehicles, or in the arms of furniture designed to hold beverages. In the preferred non-limiting embodiment cylindrical wall 32 is coaxial with cylindrical wall 18 to place the anchor structure below the potentially heavier element; the beverage container. The exterior circumference of cylindrical wall 32 may be less than the interior circumference of cylindrical wall 18 as shown in the non-limiting preferred example.

Floor 16 can extend across the bottom of cup portion 14 to be coextensive with the internal area of cylindrical wall 18. However, in a preferred non-limiting embodiment floor 16, is disposed within cylindrical wall 32, bifurcating the hollow region created by open end 34. As a result, a lip 20 is formed to transition cylindrical wall 18 and cylindrical wall 32 (cup portion 14 and anchoring mechanism 32). In this way, cup portion 14 can accommodate long and slender containers such as a water bottle or wider container such as a BIG GULP® cup within the same main body 12.

Main body 12 also includes an accessory portion 22 extending from cylindrical wall 18. A floor 24 extends from cylindrical wall 18. A first wall 26 extends upward from floor 24 as well as out from cylindrical wall 18. A second wall 30 extends upward from floor 24 as well as out from cylindrical wall 18 in an opposed facing relation with the wall 26. A wall 28 extends upward from floor 24, in opposed facing relation with cylindrical wall 18, extending from first wall 26 to second wall 30 to form a substantially rectangular enclosure having an open end 38 for receiving an electronic accessory such as a mobile phone in which the outer surface of cylindrical wall 18 forms an interior wall of accessory portion 22.

The width and length of the enclosure is slightly larger than the thickness and width of a standard mobile phone so as to receive a mobile phone while allowing quick and easy release. When sized correctly, in the preferred non-limiting embodiment, cylindrical wall 18 extends into the enclosure and provides a support wall for propping a cellular phone in the upright position when the mobile phone is within the enclosure. While the enclosure shape in the preferred non-limiting embodiment is substantially rectangular, it is understood that a square is a form of rectangle and that other shapes sized to accommodate a mobile phone are within the scope of the invention for accessory portion 22. Furthermore, in a preferred, non-limiting, embodiment main body 12 is a unitary construction, resulting from injection molding manufacture.

During use, holder 10 is inserted cylindrical wall 32 first into a standard cup holding device such as in a vehicle, a chair or the like. The length of cylindrical wall 32 extending from cup portion 14 need only be sufficient to secure/anchor main body 12 to the cup holder, and sufficiently hold within the cup holder to prevent main body 12 from being released from the cup holder during use. In a preferred embodiment, cylindrical wall 32 has a length less than the length from lip 22 to a bottom of a cup holder when main body 20 is maintained in the cup holder. In this way, while cylindrical wall 32 anchors main body 12 to the cup holder, lip 20 and floor 24 rests upon any other structure surrounding the cup holder to provide further stability for holder 10.

Once holder 10 is secured, the user would place a can, cup or bottle of beverage into cup portion 14, and depending on the circumference of the beverage container the beverage container would descend until it contacted lip 20 or floor 16; at which point it would be stabilized in place either by cylindrical wall 18 or cylindrical wall 32 respectively. Then, or prior to, a user would place their electronic accessory such as the mobile phone into accessory portion 22 through open top 38 into the enclosure of accessory portion 22 until contacting floor 24. The curved surface of cylindrical wall 18 extending into the enclosure stabilizes the accessory in an upright position. In a preferred non-limiting embodiment, holder 10 may be formed of a unitary molded construction. Additionally, at least cylindrical wall 18 may be formed of a thermally insulating, nonabsorbent material preventing condensation or liquid from passing from the cup portion 14 to the accessory portion 22 to damage the electronic accessory contained therein.

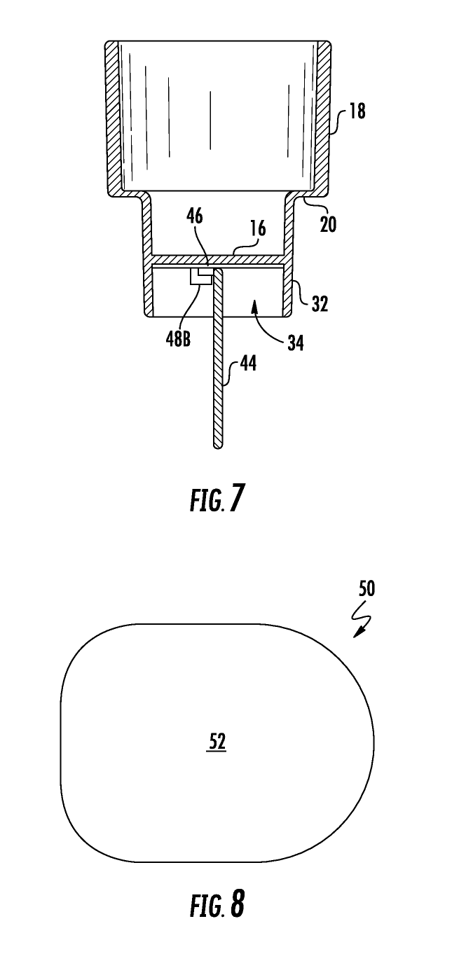

A prefabricated cup holder, such as those provided in cars, is not always available for use, such as when the user is at the beach, or in the woods away from vehicles and furniture which would contain the pre-existing cup holder to anchor holder 10 therein. Reference is now also made to FIGS. 6 and 7 in which an anchoring assembly constructed in accordance with a second embodiment of the invention is provided. An anchoring structure 40 includes a main body 44 formed as a spike. The outer diameter of spike 44 at its greatest outer diameter is less than the inner diameter of cylindrical wall 32. In a preferred non-limiting embodiment, spike body 44 is formed as vanes to have less weight, and provide less resistance to insertion into the ground, without sacrificing structural integrity. A top of spike body 44 is preferably flat to slidably contact floor 16. Tabs 42A, 42B extend from spike body 44 at the top of the spike body 44; the surface engaging floor 16. Tabs 42A and 42B are positioned substantially 180° from each other about the circumference of top 46.

Reference is now made to FIG. 5 in which a hooking mechanism 48 extending from floor 16 towards open end 34 of cylindrical wall 32 is shown. As seen in FIG. 3 two hooking mechanisms 48A, 48B are provided on floor 16 and positioned substantially 180° from each other. Each hooking mechanism 48A, 48B is dimensioned to receive and engage a respective tab 42A, 42B therein. During use, spike main body 44 is inserted into opening 34 of cylindrical wall 32 so that top 46 is flush with floor 16. Spike main body 44 is then rotated until hooking mechanisms 48A, 48B engage a respective tab 42A, 42B securing anchor 40 to main body 12. Holder 10 may then be driven into the ground utilizing spike body 44 to anchor holder 10 in the sand at the beach, or in the dirt at a picnic. To release anchoring mechanism 40 from cylindrical wall 32, it is merely rotated in the opposite direction to disengage tabs 42 from respective hooking mechanisms 48 and removed through opening 34. It should be noted, that while two hooking mechanisms and tabs are shown in the preferred non-limiting embodiment, only one hooking tab is required, and more may be used.

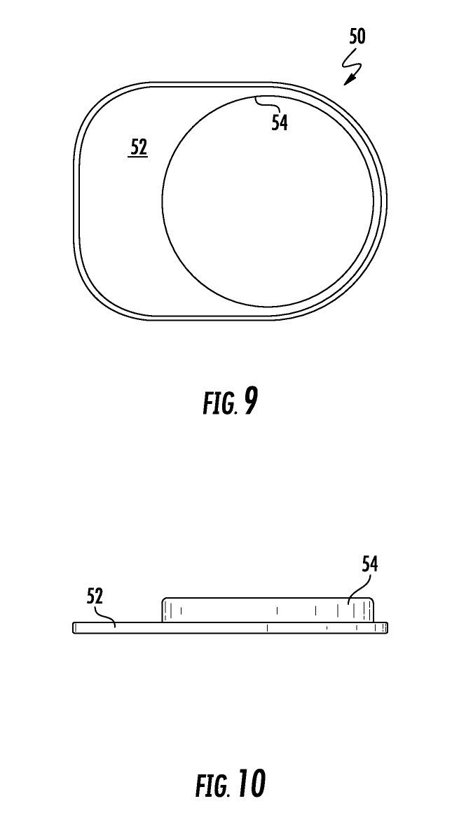

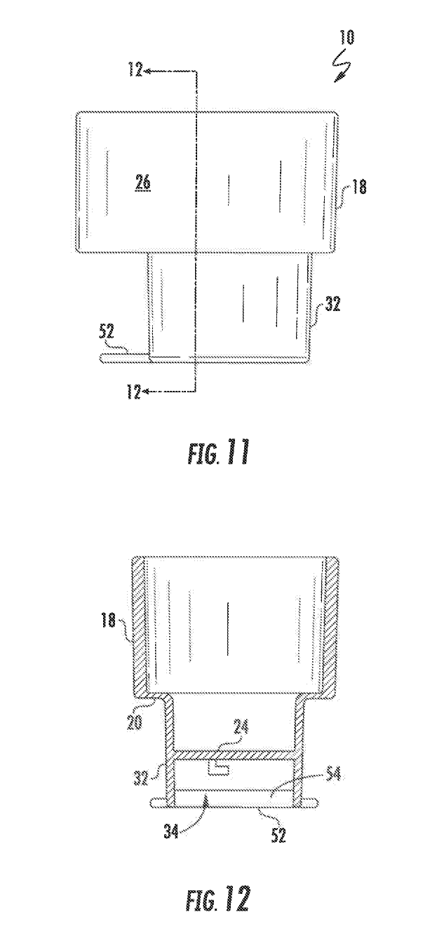

Reference is now made to FIGS. 8-13 in which an anchoring mechanism constructed in accordance with a third embodiment of the invention applicable for environments where a spike would not work and there is no cup holder to receive cylindrical wall 32. A foot is provided to be received within opening 34 to provide stability for main body 12 when holder 10 is used on a flat surface.

The third embodiment of the anchoring mechanism is a foot, generally indicated as 50. Foot 50 includes a platform 52 and a third cylindrical wall 54 extending from platform 52. Cylindrical wall 54 has an outer circumference sized to be received within opening 34 of cylindrical wall 32 while providing a releasable tension fit within the interior surface of cylindrical wall 32.

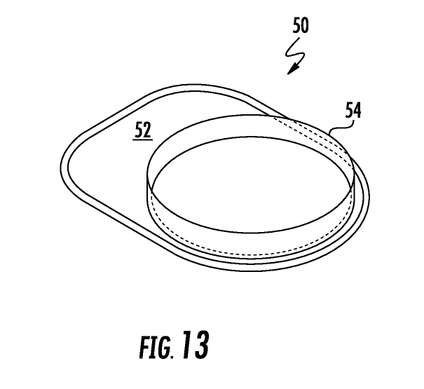

As will be understood by those skilled in the art, platform 52 is substantially planar to provide a surface to rest on other planar surfaces which enables holder 10 to be utilized on tables, the ground, and other furniture which has a substantially planar horizontal surface. The area required for platform 52 is a function of the weight of platform 52 relative to the weight of main body 12 and the beverage container. The greater the weight of platform 52 as compared to the weight of main body 12, the smaller the area required for platform 52; conversely, the greater the weight of main body 12 relative to platform 52, the larger footprint required for platform 52 to provide the same stability for holder 10. Additionally, foot 50 is secured to main body 12 by a tension fit between the outer circumference of cylindrical wall 54 and an inner circumference of cylindrical wall 32. No other engagement is required. Therefore, although cylindrical wall 54 may be any height, including a length greater than the distance from opening 34 2 floor 16, as seen in FIG. 12 all that is required is a sufficient height to engage main body 12 without enabling disengagement without a force greater then mirror bumping into, or utilizing of, holder 10.

During use of the third embodiment, all that is required is that cylindrical wall 54 be inserted into opening 34. Then holder 10 is used as described above in connection with the first embodiment.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are Intended to cover all of the generic and specific features of the invention herein described, and all statements of the scope of the invention which, as a matter of language, might be said to fall there between.

1. A holder for a beverage container and an electronic accessory comprising:
a main body, the main body including:
a first open ended compartment, the first compartment being substantially cylindrical;
a second open ended compartment extending from and being in facing relation with the first compartment, the second compartment being substantially rectangular; and
a base extending from the housing in a direction away from the first compartment and being substantially cylindrical.

2. The holder of claim 1, wherein the base is coaxial with the first compartment.

3. The holder of claim 1, wherein the first compartment is formed by a cylindrical wall and an outer surface of the cylindrical wall forms an inner wall of the second compartment.

4. The holder of claim 1, wherein a diameter of the first compartment is not equal to a diameter of the base, and a lip is formed between the first compartment and the base.

5. The holder of claim 1, wherein the base is open ended.

6. The holder of claim 1, further comprising a floor disposed within one of the base and the first compartment.

7. The holder of claim 5 further comprising an anchor releasably disposed within an open end of the base.

8. The holder of claim 7 further comprising two or more hooks extending from the floor towards the open end of the base and the anchor having two or more tabs extending therefrom to engage a respective one of the two or more hooks.

9. The holder of claim 7, wherein the anchor comprises a spike body.

10. The holder of claim 9, wherein the spike body is formed as a plurality of vanes.

11. The holder of claim 7, wherein said anchor is a foot, the foot having a platform, and a cylindrical wall extending from the platform, the cylindrical wall having an outer circumference sized to be received within the open end of the base to provide a tension fit therebetween.

12. The holder of claim 1, wherein the first compartment, second compartment, and base are formed as a unitary structure.
